(19) United States
(12) Patent Application Publication
(10) Pub. No.: US 2022/0229821 A1
(43) Pub. Date: Jul. 21, 2022

(54) DATA RESTORATION USING DYNAMIC DATA STRUCTURE ALTERING

(71) Applicant: NAMOGOO TECHNOLOGIES LTD., Herzeliya (IL)

(72) Inventors: Ohad Moti Greenshpan, Herzeliya (IL); Chemi Menachem Katz, Herzeliya (IL); Dor Baz, Petah Tikva (IL)

(21) Appl. No.: 17/616,516

(22) PCT Filed: Jul. 14, 2020
(86) PCT No.: PCT/IL2020/050789

§ 371 Date: Dec. 3, 2021

Related U.S. Application Data
(60) Provisional application No. 62/876,310, filed on Jul. 19, 2019.

(51) Int. Cl. G06F 16/21; G06F 16/22; G06F 16/23

(52) U.S. Cl. CPC G06F 16/213; G06F 16/2358; G06F 16/2282

(57) ABSTRACT

Data management systems and methods are disclosed for managing a database. The systems and methods collect a data set stored in a database. A schema associated with the data set identified and stored with the data set and an associated set of changes in an archival data store. The systems and methods receive a request associated with the data set stored in the archival data store. In response to the request, in view of the set of changes, a temporary data structure including the data set in accordance with the schema is generated in the database, the temporary data structure. The data set is loaded from the temporary data structure to a data structure corresponding to a current schema of the database.

### TECHNICAL FIELD

Aspects and implementations of the present disclosure relate to data management, and more specifically, to restoring data using dynamically altered data structures in a database management system.

### BACKGROUND

The management of large volumes of data presents many challenges due to increasing data volumes and data varieties. There is a need to store high volumes of data that change rapidly, and still maintain the ability to query and analyze the data efficiently. Databases provide analytical tools for structured data, but are expensive, and storing data in a database for a long timeframe can be costly and cause a decrease in performance.

One conventional approach is to unload the data from the database to a storage account and load the data back to the database as needed. However, the schema of data structures (e.g., tables) within the database changes regularly (i.e., columns are added, columns are deleted, column types are changed, etc.), and as a result, the loading of historical data is often likely to fail due to schema incompatibility at different dates and times.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 depicts an illustrative an example computing system, in accordance with one or more implementations of the present disclosure.

FIG. 2 depicts a process flow including aspects of an example method to unload a data set to an archival data store and load the data set to a temporary data structure of a database, in accordance with one or more implementations of the present disclosure.

FIG. 3 depicts a process flow including aspects of an example method to manage a data structure for the loading of one or more data sets from an archival data store to a database.

FIG. 4 depicts a block diagram of an illustrative computer system operating in accordance with aspects and implementations of the present disclosure.

### DETAILED DESCRIPTION

Aspects and implementations of the present disclosure address the above-identified problems by a data management system providing dynamic data structure altering. In an embodiment, the data management system is configured to retrieve and load into a database a set of historical data that was previously unloaded from the database. The historical data can be unloaded from a database and stored in a data store (e.g., a lower availability storage area). The data store can be a lower availability storage area as compared to the database. A schema associated with the data being unloaded from the database, also referred to as “unloaded data”, is stored with the unloaded data in the data store (also referred to as an “archival data store”). After the data is unloaded from the database, the data can be deleted from the database to increase the available storage of the database.

The data management system can retrieve the previously unloaded data from the data store for loading back into the database (e.g., restoration of the data for further actions via the database). For example, a database request associated with at least a portion of the unloaded data (e.g., a query of the database) can be received and processed by the data management system. The schema associated with the unloaded data (i.e., the schema applied to the data of the database at a time the unloaded data was collected and stored in the second data store) may be different from a schema applied by the database at a time of the request (also referred to a as a “current schema” of the database). In response to the request, the data management system can retrieve the requested data from the archival data store, delete the retrieved data from the archival data store, and alter or edit the data to correspond or fit a data structure (e.g., a table) within the in accordance with the current schema. Advantageously, the data management system of the present disclosure solves the aforementioned problems with the conventional approaches by managing data stored in accordance with multiple different schemas, and loading the data from a archival data store into a single consistent schema in the database that can be used for data query and data analysis operations. Furthermore, data management system allows for the use of the second data store as an extension to the database to store large amounts of data at a lower cost, and load the previously unloaded data back into the database upon request.

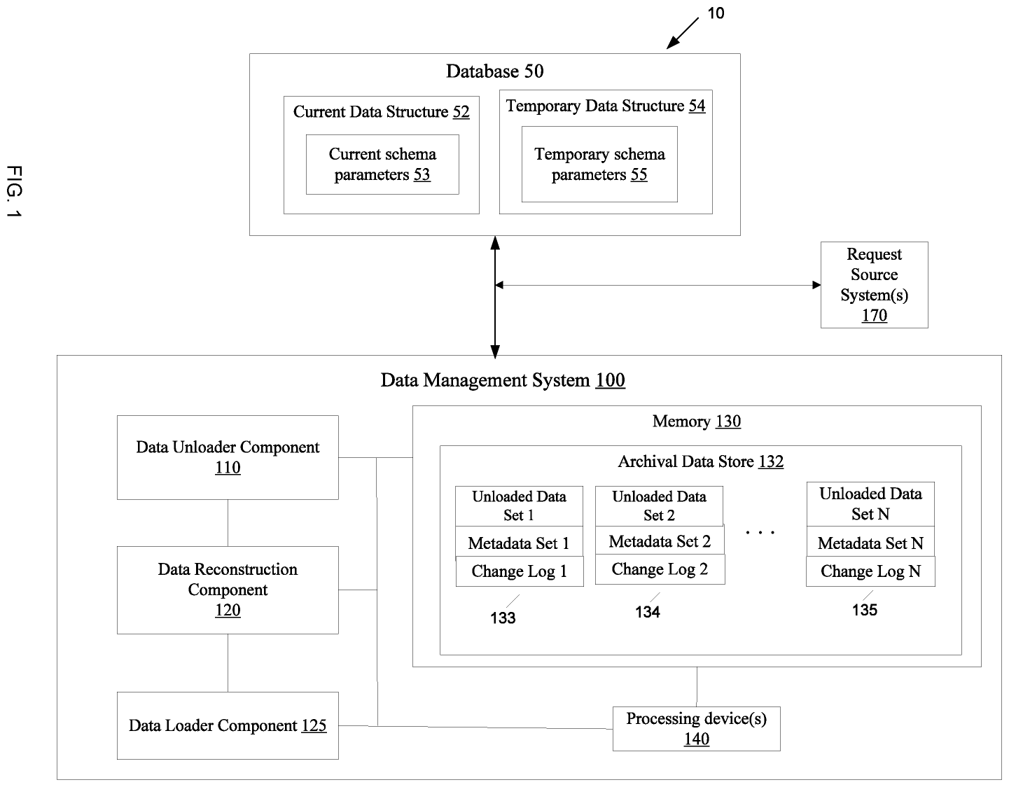

FIG. 1 depicts an illustrative computing environment 10, in accordance with one or more embodiments of the present disclosure. The computing environment 10 includes a data management system 100 configured to manage data associated with a database 50. In an embodiment, the database 50 can be a data storage area maintained on one or more computing devices (e.g., servers) to store data for access by one or more computing systems. In an embodiment, the database 50 can be a high-availability storage area storing data that can be accessed or queried by one or more request source systems 170. In an embodiment, the request source system 170 can include any suitable computing system such as a personal computer (e.g., a desktop computer, laptop computer, server, a tablet computer), a workstation, a handheld device, a web-enabled appliance, a gaming device, a mobile phone (e.g., a Smartphone), an eBook reader, a camera, a watch, an in-vehicle computer/system, or any computing device enabled with one or more web browser 5.

In an embodiment, the data management system 100 can be communicatively connected to the database and the request source systems 170 via one or more networks (not shown). Example networks can include a public, private, wired, wireless, hybrid network, or a combination of different types of networks. The network 1530 may be implemented as a local area network (“LAN”), a wide area network (“WAN”) such as the Internet, a corporate intranet, a metropolitan area network (“MAN”), a storage area network (“SAN”), a Fibre Channel (“FC”) network, a wireless cellular network (e.g., a cellular data network), or a combination thereof.

In an embodiment, the data management system 100 includes one or more components configured to execute the functions, methods, operations, and processes described in detail herein. In an embodiment, the data management system 100 includes a data unloader component 110, a data reconstruction component 120, a data loader component 125, one or more processing devices 140, and a memory 130 including an archival data store 132.

In an embodiment, the data unloader component 110 unloads historical data (also referred to as a “data set” or “unloaded data set”) from the database 50 for storage in the archival data store 132. In an embodiment, the data unloader component 110 also unloads a metadata set including information identifying a data schema that is compatible with the unloaded data.

In an embodiment, the data unloader component 110 identifies a database table schema that is applicable at the current time (e.g., current schema parameters 53 associated with a current data structure 52 storing the data to be unloaded). In an embodiment, the data unloader component 110 serializes the schema and stores the serialized schema (e.g., metadata set 1 of FIG. 1) with the unloaded data (e.g., unloaded data set 1 of FIG. 1) in the archival data store 132. In an embodiment, the data unloader component 110 checks a data log of the database 50 to identify one or more changes that were made since a previous unloading operation and stores a change log (e.g., change log 1 of FIG. 1) including the identified changes with the unloaded data in the archival data store 132. In an embodiment, during each unloading operation, the data unloader component 110 unloads, retrieves, fetches, etc. an unloaded data set (e.g., unloaded data set 1, unloaded data set 2 . . . unloaded data set N), a corresponding metadata set (e.g., metadata set 1, metadata set 2 . . . metadata set N), and a corresponding change log (e.g., change log 1, change log 2 . . . change log N) for storage in the archival data store 132.

In an embodiment, the data unloader component 110 executes the unloading process to unload the schema for each database table to enable the subsequent loading of the historical data by the data loader component 125, as described in greater detail below. For example, the metadata set unloaded for each data set can include one or more schema parameters including column names (e.g., ‘id’, ‘name’, ‘address’, etc.), column types/format (e.g., ‘decimal number’, ‘string’, etc.), column sizes (e.g., 1 byte, 4 bytes, etc.). In an embodiment, the data unloading process includes storing a change log including a set of database commands recording the changes made to the database schema, such that any change to the database schema is recorded and saved.

In an embodiment, the unloading of the data sets from the database 50 for storage in the archival data store 132 can be performed periodically according to any suitable timeframe or frequency (e.g., every minute, hourly, daily, weekly, monthly, etc.). The unloading timeframe can be managed by the data unloader component 110 to initiate the unloading process associated with a portion of data stored in the current data structure 52 of the database 50 for storing in the archival data store 132. In an embodiment, the unloading can be performed with respect to data stored in one or more partitions or locations of the database, including data associated with a particular entity (e.g., a customer system), application, request, etc.

In an embodiment, the data management system 100 can employ a data retention specification such that each data structure (e.g., table) in the database 50 has a defined time interval spanning a start time (also referred to as “start time”) and an end time (also referred to as “end time”). For every time interval defined by the data management system 100 (e.g., hourly, daily, weekly, monthly, etc.), the data unloading process performed by the data unloader component 110 unloads data having a timestamp that is older than the start time of the database data structure and stores the unloaded data into a file maintained in an archival data store 132. In an embodiment, the files (e.g., file 133, 134, 135 of FIG. 1) including the unloaded data are cataloged according to date.

In an embodiment, the data reconstruction component 120 is configured to receive a request (e.g., a request initiated by a request source system 170) to load stored data to the database 50. In an embodiment, the request can relate to one or more data sets stored in the archival data store 132 (e.g., data sets associated with one or more unloading timeframes). In an embodiment, in response to the request, the data reconstruction component generates a temporary data structure (e.g., a database table) in the database 50 (also referred to as a “temporary table”) with a schema that correlates to the metadata set corresponding to a first timeframe associated with the request.

In an embodiment, the schema of the temporary data structure 54 is defined by one or more temporary schema parameters 55 generated by the data reconstruction component 120 in accordance with a metadata set identified at an associated timeframe. In an embodiment, for each subsequent loading timeframe, the data reconstruction component 12 alters the temporary table by applying changes according to the metadata set and corresponding change log, in order to update or alter the temporary table in accordance with a corresponding data schema. In an embodiment, after the temporary table finishes loading, the data reconstruction component 120 alters the temporary data structure 54 to the current schema parameters 53 of the current data structure 52.

In an embodiment, at each interval of the requested or predetermined timeframe, the data loader component 125 is configured to load the stored data to the temporary table (e.g., the temporary table as created and altered by the data reconstruction component 120).

In an embodiment, after the requested data is loaded to the temporary database table, the data management system checks the schema of the original table, and the changes log, and alters the temporary database table to match the current schema of the original table. This function makes the entire date range accessible and configured for a query within the current schema (i.e., the updated schema applied by the data management system). In an embodiment, once the data in the temporary data structure 54 is in the updated schema (e.g., in accordance with the current schema parameters 53), the data is loaded or inserted into the database 50 and becomes queryable or otherwise accessible (e.g., by a request source system 170). In an embodiment, the data loader component 125 loads all the data that is in the current schema in the temporary data structure 54 (e.g., the reconstructed table) to a permanent data structure of the database 50 (e.g., the current data structure 52).

Advantageously, with respect to data unloaded at various times or time frames, the data loader component 125 can dynamically (e.g., in response to a request) load the data for the requested period in a new or updated schema generated with the dynamic schema altering process to ensure all of the archived data can be re-loaded into the database 50 in a consistent data structure (e.g., in accordance with an up-to-date or current schema).

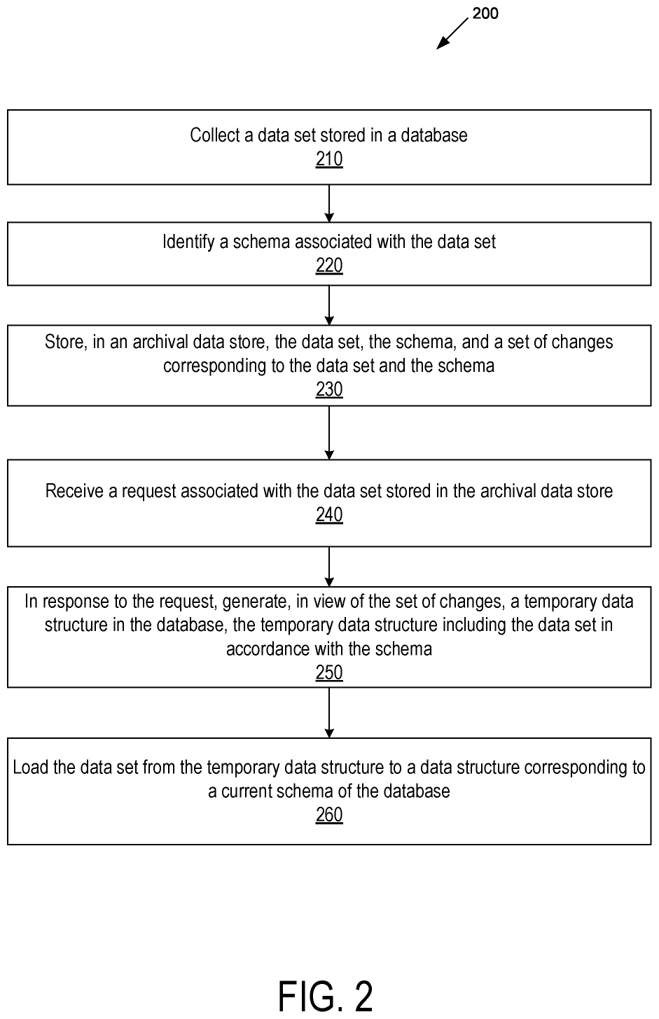

FIG. 2 depicts a flow diagram of aspects of a method 200 for loading data from an archival data store to a database using a dynamically altered data structure, in accordance with embodiments of the present disclosure. In an embodiment, method 200 relates to unloading data from a database to an archival data store, along with the data schema that is compatible with the unloaded data, and dynamically loading the data back to the database in a new or updated schema generated with a dynamic schema altering process to enable the data to be loaded into a consistent and up-to-date (e.g., current) data structure of the database. In an embodiment, the method is performed by processing logic that may comprise hardware (circuitry, dedicated logic, etc.), software, or a combination of both. In one implementation, the method is performed by one or more elements depicted and/or described in relation to FIG. 1 (including but not limited to the data management system 100), while in some other implementations, one or more blocks of FIG. 2 may be performed by another machine or machines.

For simplicity of explanation, methods are depicted and described as a series of operations. However, the operations in accordance with this disclosure can occur in various orders and/or concurrently, and with other operations not presented and described herein. Furthermore, not all illustrated operations may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In operation 210, the processing logic collects a data set stored in a database. In an embodiment, the processing logic unloads or fetches a data set (e.g., the first data) from the database periodically according to any suitable time interval or timeframe (also referred to as the “unloading timeframe”) or frequency (e.g., every minute, hourly, daily, weekly, monthly, etc.). The unloading timeframe can be managed and used to initiate the unloading process and fetch the data set from a data structure of the database 50 for storing in an archival data store. In an embodiment, the unloading process can be initiated by a request, instruction or command. In an embodiment, the unloading can be performed with respect to the data set stored in one or more partitions or locations of the database, including data associated with a particular entity (e.g., a customer system), application, request, etc.

In operation 220, the processing logic identifies a first schema associate with the first data. In an embodiment, the first schema is identified by examining the schema associated with the data structure that stored in the first data in the database. In an embodiment, the processing logic identifies a database data structure (e.g., table) schema that is applicable at the current time (e.g., the time the first data is unloaded) and serializes the schema (e.g., the schema associated with the unloaded data set), such that the serialized schema can be stored with the unloaded data set. In an embodiment, the schema can be defined by a set of schema parameters, including, for example, a column name parameter, a column type parameter, a column format parameter, a column size parameter, a column order or sequence parameter, a parameter identifying a number of columns, a row name parameter, a row type parameter, a row format parameter, a row size parameter, a row order or sequence parameter, a parameter identifying a number of rows, etc.

In operation 230, the processing logic stores, in an archival data store, the data set, the schema, and a set of changes corresponding to the data set and the schema. In an embodiment, the processing device, as part of the data unloading process, fetches a change log including a set of database commands recording changes, updates, modifications, or alterations made to the database schema.

In operation 240, the processing logic receives a request associated the data set stored in the archival data store. In an embodiment, the request can include a query of historical data (e.g., one or more data sets including the data set unloaded in operation 210) that was previously unloaded from the database to the archival data store. In an embodiment, the request can relate to data that was unloaded at different time intervals (e.g., a first time interval, a second time interval, a third time interval, etc.). In an embodiment, the processing logic can load data from an oldest requested time (e.g., the first time interval) to a newest requested time (e.g., an Nth time interval).

In operation 250, in response to the request, the processing logic generates in view of the set of changes, a temporary data structure in the database, the temporary data structure including the data set in accordance with the schema. In an embodiment, the processing logic generates the temporary data structure with the first schema. In an embodiment, the set of changes can include one or more database commands or instructions that change, update, modify, or alter one or more schema parameters associated with the data structure of the database.

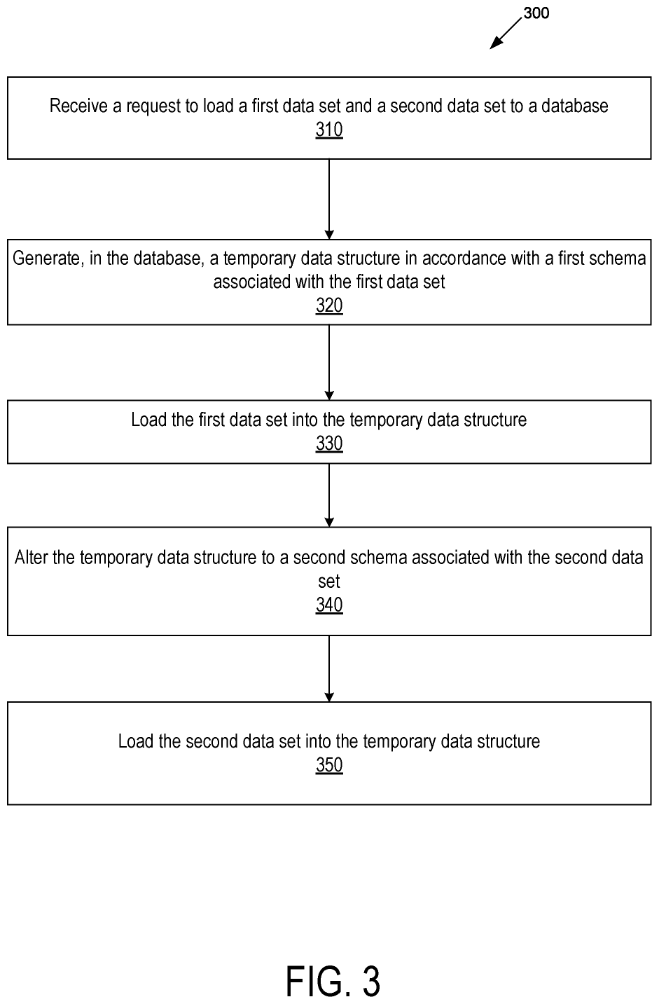

For example, the data set of operation 250 can be data unloaded at a second time interval. In this example, the temporary data structure having a schema associated with a first time interval (e.g., a set of data that was unloaded prior to the unloading of the data set in operation 210) can be updated in view of the set of changes associated with the data set, as described in greater detail with respect to FIG. 3.

In an embodiment, the processing logic applies the set of changes to generate the temporary data structure, simulating the original sequence of events that occurred with respect to the data structure of the database during the multiple unloading intervals.

In operation 260, the processing logic loads the data set from the temporary data structure to a data structure corresponding to a current schema of the database. In an embodiment, after the requested data is loaded to the temporary database table, the processing logic determines the current schema of a data structure of the database and the set of changes and alters the temporary data structure to match the current schema of the database. Advantageously, in an embodiment, the loading of the data in the current schema of the database enables each data set corresponding to a time range of the request to be accessible and configured for a query within the current schema (i.e., the updated schema applied by the processing device). In an embodiment, once the data set in the temporary database table is in the updated schema (e.g., the current schema), it is inserted into the database and is enabled for querying, searching, performing analytics, etc.

In an embodiment, before each batch of data (e.g., multiple different data sets corresponding to a time range associated with the request) is loaded into the database, the temporary data structure is altered to fit an updated schema corresponding to a respective data set, followed by the loading of that data set into the temporary data structure. In an embodiment, operations 250 and 260 can be applied iteratively by the processing device until an entire data set (e.g., multiple different data sets) corresponding to the requested timeframe is loaded into the temporary data structure and then into a data structure of the database, as described in greater detail with respect to FIG. 3. For example, the processing logic can load another data set (e.g., data unloaded to the archival data store at a second time interval that is later than a first time interval associated with the data set unloaded in operation 210) by checking the temporary data structure having the schema and applying a set of changes associated with the another data set to update or alter the temporary data structure to a second schema. In an embodiment, in order to load the next batch of data (e.g., data that is from a later time), the data management system checks the schema of this newer data and the log of the changes that were made between these two time intervals, and applies them to the temporary database table to update the schema and make it consistent.

FIG. 3 depicts a flow diagram of aspects of a method 300 for dynamically altering a temporary data structure to load multiple data sets from an archival data store into a database, in accordance with embodiments of the present disclosure. In an embodiment, The method is performed by processing logic that may comprise hardware (circuitry, dedicated logic, etc.), software, or a combination of both. In one implementation, the method is performed by one or more elements depicted and/or described in relation to FIG. 1 (including but not limited to the data management system 100), while in some other implementations, one or more blocks of FIG. 3 may be performed by another machine or machines.

For simplicity of explanation, methods are depicted and described as a series of operations. However, the operations in accordance with this disclosure can occur in various orders and/or concurrently, and with other operations not presented and described herein. Furthermore, not all illustrated operations may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices.

In operation 310, the processing logic receives a request to load a first data set and a second data set to a database. In an embodiment, the request may indicate that multiple data sets associated with a requested time frame are to be loaded into the database. For example, the request may indicate that all data associated with a particular client within a date range (e.g., all sales data associated with Client X with date range Y) is to be loaded into the database for one or more query operations. In an embodiment, the first data set can include sales data relating to a first portion of the data range Y and the second data set can include sales data relating to a second portion of the date range Y.

In this example, the first data set may have been unloaded from the database to an archival data store at a first time interval and the second data set may have been unloaded from the database to the archival data store. Accordingly, in order to service the request associated with the requested time frame (e.g., date range Y), the processing logic initiates a loading process to load the first data set and the second data set from the archival data store to the database.

In operation, 320, the processing logic generates, in the database, a temporary data structure in accordance with a first schema associated with the first data set. In an embodiment, the processing logic uses a file including the first data set, the first schema and a first change log associated with the first data set. In an embodiment, the processing logic builds the one or more commands to update the schema of the temporary data structure based on the one or more parameters of the first schema and the first change log.

In operation 330, the processing logic loads the first data set into the temporary data structure. In an embodiment, the processing logic prepares the first data set for loading into the temporary data structure in accordance with the first schema.

In operation 340, the processing logic alters the temporary data structure to a second schema associated with the second data set. In an embodiment, the temporary data structure is altered to match the second schema following a loading of the first data set into a data structure of the database (e.g., a permanent or current data structure of the database). In an embodiment, the processing logic executes a reconstruction process which includes loading historical data (e.g., the first data set and the second data set) from an oldest requested time (e.g., the first portion of date range Y) to a newest requested time (e.g., the second portion of data range Y) and creates the temporary data structure according to the schema of the oldest data batch requested (e.g., the first schema associated with the first data set) and loads the data for the corresponding date to the temporary data structure. In an embodiment, in order to load the next batch of data (e.g., the second data set), the processing logic checks the schema of this newer data (e.g., the second second) and the log of the changes that were made between these two time intervals (e.g., the changes made to the database between the first portion of date range Y and the second portion of date range Y), and applies the identified changes to the temporary data structure to establish the second schema.

An example of a change to the data structure that can be identified by the processing logic and used to alter the temporary data structure includes a column addition. A column addition change can be identified if a subsequent schema (e.g., the second schema) contains a column that did not exist in the previous schema (e.g., the first schema). In this example, a column is added to the temporary data structure and a ‘null’ value is inserted into the temporary data structure for one or more older rows. In this example, when the processing logic encounters this change, the new column is added to the temporary data structure being reconstructed.

Another example of a change to the data structure that can be identified by the processing logic and used to alter the temporary data structure includes a column deletion. In this example, a column is deleted from the temporary data structure if a column is missing in a second schema, indicating that the column was removed as a result of a change to a previous schema (e.g., the first schema). In this example, the processing logic can either permanently remove the deleted column from the temporary data structure and delete the values within the column or retain the deleted column with null values for the newer rows corresponding to the second data set.

Another example of a change to the data structure that can be identified by the processing logic and used to alter the temporary data structure includes a change to a column size or a column type. In this example, in an embodiment, if a column changes size or type is identified, the processing logic can change the column type to be the more current type and cast all values in the table to the updated type. For example, if a column having a decimal type from a previous day needs to be changed to a whole number in a later date, the processing logic can change the type to a whole number and round up or round down the decimal values accordingly. In this example, in an embodiment, if a column changes size or type is identified, the processing logic can change the column type to the more inclusive column type. For example, if a decimal type from a previous day is to be changed to a whole number for a later date, the processing logic can keep the decimal type since it can hold whole number values.

Another example of a change to the data structure that can be identified by the processing logic and used to alter the temporary data structure includes a column name change. In this example, in an embodiment, if a column name change is identified (or a new column was added in place of an older column), the processing logic can refer to the one or more schema change logs to determine the manner in which to alter the temporary data structure. For example, the processing logic can identify a series of deletion-insertion actions indicating that a first column has been replaced by a second column, and update the temporary data structure accordingly.

Another example of a change to the data structure that can be identified by the processing logic and used to alter the temporary data structure includes a column order change. In this example, in an embodiment, if the processing logic detects the order of the columns has changed, the processing logic can alter the column order in the temporary data structure before loading the data into the temporary data structure.

With reference to FIG. 3, in operation 350, the processing logic loads the second data set into the temporary data structure. In an embodiment, the second data set is loaded into the temporary data structure that has a schema that is altered to accommodate or receive the second data set. In an embodiment, the processing logic can load the first data set and the second data set from the temporary data structure to a data structure of the database, such that the first data set and second data set can be queried, searched, analyzed, updated, etc.

In an embodiment, the processing logic can alter the temporary data structure in accordance with the first schema, load the first data set into the temporary data structure, load the first data set from the temporary data structure into a data structure of the database, alter the temporary data structure in accordance with the second schema, load the second data set into the temporary data structure, and load the second data set from the temporary data structure to the data structure of the database.

In an embodiment, the processing logic can alter the temporary data structure in accordance with the first schema, load the first data set into the temporary data structure, alter the temporary data structure in accordance with the second schema, load the second data set into the temporary data structure, and load both the first data set and the second data set from the temporary data structure to the data structure of the database.

Advantageously, execution of method 300 enables the processing logic to load multiple different data sets into a database using a temporary data structure having a schema that can be dynamically altered to receive the multiple different data sets.

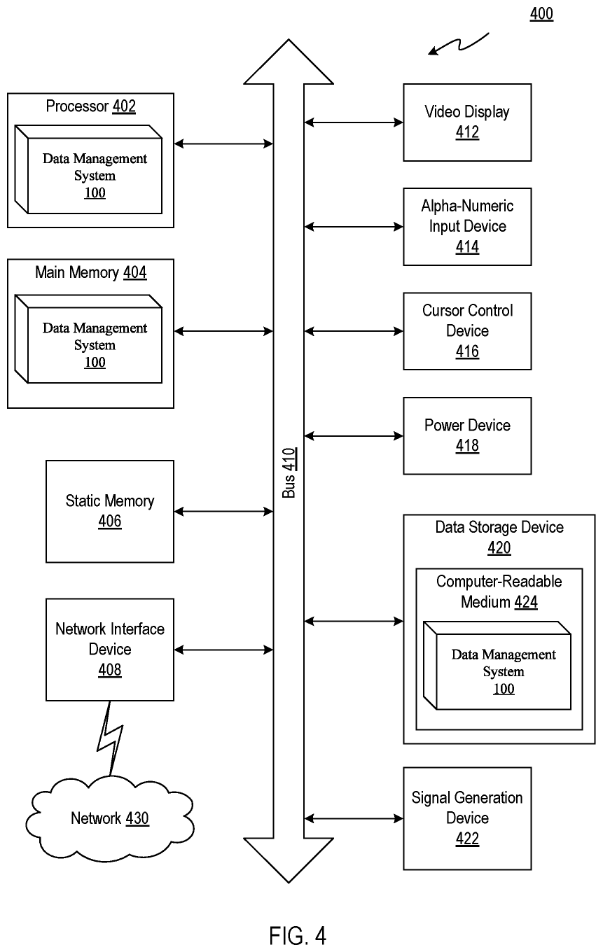

FIG. 4 depicts an illustrative computer system within which a set of instructions, for causing the machine to perform any one or more of the methodologies discussed herein, may be executed. In alternative implementations, the machine may be connected (e.g., networked) to other machines in a LAN, an intranet, an extranet, or the Internet. The machine may operate in the capacity of a server machine in client-server network environment. The machine may be a computing device integrated within and/or in communication with a vehicle, a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 400 includes a processing system (processor) 402, a main memory 404 (e.g., read-only memory (ROM), flash memory, dynamic random access memory (DRAM) such as synchronous DRAM (SDRAM)), a static memory 406 (e.g., flash memory, static random access memory (SRAM)), and a data storage device 416, which communicate with each other via a bus 408.

Processor 402 represents one or more general-purpose processing devices such as a microprocessor, central processing unit, or the like. More particularly, the processor 402 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 402 may also be one or more special-purpose processing devices such as an application specific integrated circuit (ASIC), a field programmable gate array (FPGA), a digital signal processor (DSP), network processor, or the like. The processor 402 is configured to execute instructions of an adaptive code generation system 100 for performing the operations discussed herein.

The computer system 400 may further include a network interface device 422. The computer system 400 also may include a video display unit 410 (e.g., a liquid crystal display (LCD) or a cathode ray tube (CRT)), an alphanumeric input device 412 (e.g., a keyboard), a cursor control device 414 (e.g., a mouse), and a signal generation device 420 (e.g., a speaker).

The data storage device 416 may include a computer-readable medium 424 on which is stored one or more sets of instructions (e.g., instructions executed by the adaptive code generation system 100) embodying any one or more of the methodologies or functions described herein. The instructions of the adaptive code generation system 100 may also reside, completely or at least partially, within the main memory 404 and/or within the processor 402 during execution thereof by the computer system 400, the main memory 404 and the processor 402 also constituting computer-readable media. The instructions of the adaptive code generation system 100 may further be transmitted or received over a network via the network interface device 422.

While the computer-readable storage medium 424 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “processing,” “comparing,” “identifying,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Aspects and implementations of the disclosure also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform certain operations. In addition, the present disclosure is not described with reference to any particular programming language. It will be appreciated that a variety of programming languages may be used to implement the teachings of the disclosure as described herein.

It is to be understood that the above description is intended to be illustrative, and not restrictive. Many other embodiments will be apparent to those of skill in the art upon reading and understanding the above description. Moreover, the techniques described above could be applied to practically any type of data. The scope of the disclosure should, therefore, be determined with reference to the appended claims, along with the full scope of equivalents to which such claims are entitled.

What is claimed is:

1. A method comprising:
collecting, by a processing device, a data set stored in a database;
identifying a schema associated with the data set;
storing, in an archival data store, the data set, the schema, and a set of changes corresponding to the data set and the schema;
receiving a request associated with the data set stored in the archival data store;
in response to the request, generating, in view of the set of changes, a temporary data structure comprising the data set in accordance with the schema; and
loading the data set from the temporary data structure to a data structure corresponding to a current schema of the database.

2. The method of claim 1, wherein the schema is defined by one or more schema parameters.

3. The method of claim 1, wherein the data set is collected at a first time interval of a plurality of time intervals.

4. The method of claim 3, further comprising:
collecting, at a second interval of the plurality of time intervals, a second data set associated with a second schema and a second set of changes.

5. The method of claim 4, further comprising:
altering the temporary data structure in view of the second set of changes; and
loading the second data set into the temporary data structure in accordance with the second schema.

6. The method of claim 1, further comprising processing, via the database, a query associated with the data set.

7. The method of claim 1, further comprising deleting the data set from the database following collection of the data set from the database.

8. A system comprising:
a memory to store instructions; and
a processing device, operatively coupled to the memory, the processing device to execute the instructions to perform operations comprising:
receiving a request to load a first data set and a second data set to a database;
generating, in the database, a temporary data structure in accordance with a first schema associated with the first data set;
loading the first data set into the temporary data structure; and
altering the temporary data structure to a second schema associated with the second data set.

9. The system of claim 8, the operations further comprising loading the second data set into the temporary data structure.

10. The system of claim 8, the operations further comprising loading the first data set and the second data set into a data structure of the database.

11. The system of claim 8, wherein altering the temporary data structure comprises changing a first parameter of the first schema to match a second parameter of the second schema.

12. The system of claim 8, wherein the temporary data structure is altered in view of a set of schema changes occurring between a first time interval associated with the first data set and a second time interval associated with the second data set.

13. The system of claim 8, wherein the request comprising a query received from a system associated with an entity, and wherein the first data set and the second data set are associated with the entity.

14. A non-transitory computer readable medium comprising instructions that, if executed by a processing device, cause the processing device to perform operations comprising:
collecting a data set stored in a database;
identifying a schema associated with the data set;
storing, in an archival data store, the data set, the schema, and a set of changes corresponding to the data set and the schema;
receiving a request associated with the data set stored in the archival data store;
in response to the request, generating, in view of the set of changes, a temporary data structure comprising the data set in accordance with the schema; and
loading the data set from the temporary data structure to a data structure corresponding to a current schema of the database.

15. The non-transitory computer readable medium of claim 14, wherein the schema is defined by one or more schema parameters.

16. The non-transitory computer readable medium of claim 14, wherein the data set is collected at a first time interval of a plurality of time intervals.

17. The non-transitory computer readable medium of claim 16, the operations further comprising collecting, at a second interval of the plurality of time intervals, a second data set associated with a second schema and a second set of changes.

18. The non-transitory computer readable medium of claim 17, the operations further comprising:
altering the temporary data structure in view of the second set of changes; and
loading the second data set into the temporary data structure in accordance with the second schema.

19. The non-transitory computer readable medium of claim 15, the operations further comprising processing, via the database, a query associated with the data set.

20. The non-transitory computer readable medium of claim 15, the operations further comprising deleting the data set from the database following collection of the data set from the database.
